(19) United States
(12) Patent Application Publication
(10) Pub. No.: US 2025/0066923 A1
(43) Pub. Date: Feb. 27, 2025

(54) Aluminium Strip with Antibacterial Coating

(71) Applicants: Ishak Bakirel, Köln (DE); Annika Dierker, Düsseldorf (DE)

(72) Inventors: Ishak Bakirel, Köln (DE); Annika Dierker, Düsseldorf (DE)

(73) Assignee: Speira GmbH, Grevenbroich (DE)

(21) Appl. No.: 18/947,266

(22) Filed: Nov. 14, 2024

Related U.S. Application Data
(63) Continuation of application No. PCT/EP2023/063374, filed on May 17, 2023.

(30) Foreign Application Priority Data
May 19, 2022 (EP) 22174400.6

(51) Int. Cl. C23C 28/04; B21B 1/02; B21B 1/22; B21B 45/00; B65D 1/16; B65D 25/14; B65D 25/34; B65D 65/42; C22C 21/00; C22F 1/04

(52) U.S. Cl. CPC C23C 28/042; B21B 1/026; B21B 1/22; B21B 45/004; B65D 1/165; B65D 25/14; B65D 25/34; B65D 65/42; C22C 21/00; C22F 1/04; B21B 2001/221

(57) ABSTRACT

An aluminium strip for manufacturing a package of a solid, liquid or gaseous product consisting of an aluminium alloy. The aluminium strip has at least a one-sided or two-sided antibacterial coating. The object of proposing an aluminium strip consisting of an aluminium alloy with at least a one-sided or two-sided antibacterial coating, which can be more easily produced with very good antibacterial effect of the coating and can already provide very good antibacterial properties at extremely low concentrations of the antibacterial substance, is achieved by the antibacterial coating containing ZnMoO₄ as the antibacterial substance.

### CROSS-REFERENCE TO RELATED PATENT APPLICATIONS

This patent application is a continuation of International Application No. PCT/EP2023/063374, filed on May 17, 2023, which claims the benefit of priority to European Patent Application No. 22174400.6, filed May 19, 2022, the entire teachings and disclosures of both applications are incorporated herein by reference thereto.

### FIELD OF THE INVENTION

The invention relates to an aluminium strip for manufacturing a package of a solid, liquid or gaseous product consisting of an aluminium alloy, with the aluminium strip having at least a one-sided or a two-sided, external antibacterial coating. Furthermore, the invention relates to a method for manufacturing a corresponding aluminium strip, in which a rolling ingot or a casting strip is cast from an aluminium alloy, the rolling ingot or optionally the casting strip is homogenised, the rolling ingot or the casting strip is hot-rolled to form a hot strip, the hot strip is cold-rolled to an optional end thickness of 0.1 mm to 0.3 mm with or without at least an intermediate annealing. Finally, the invention also relates to a can lid or can body of a can, in particular a beverage can as well as a beverage can.

### BACKGROUND OF THE INVENTION

Aluminium strips used to manufacture a package of a solid, liquid or gaseous product are usually made of an aluminium alloy which is specifically adapted to the requirements for the manufacture of the package, in particular also a foodstuff package. The aluminium alloy thereby undergoes manufacturing steps from the casting of a rolling ingot or a casting strip to the cold rolling to end thickness until an aluminium strip with specific mechanical properties and a specific thickness is finally provided that is suitable for further processing for package. The aluminium strip then undergoes manufacturing steps, in particular forming steps, to provide the package of a solid, liquid or gaseous product.

A typical example of such a package is a can, in particular a beverage can. Beverage cans consist of a can lid and a can body, which are connected to each other, for example via a flange, in an air-tight manner. The can body can also be formed in two parts here.

To protect the aluminium from attack by the product, for example a beverage, aluminium strips for the manufacture of cans, in particular beverage cans, are coated with a varnish layer on the inside. An outer varnish layer, for example on the can body, is used to carry out the processing processes for the can body and to provide a decorative appearance of the can, for example to signal brand affiliation. The can lid is provided with a coating both inside and outside, in particular a varnish layer to protect the product from aluminium penetration.

From the Japanese patent application JP H09 77077 A, a beverage can is now known in which an antibacterial substance was applied to the outer surface of the beverage cans in order to prevent a colonisation of the beverage can with microbes during manufacture, in particular after filling the beverage cans. Zinc-based inorganic antibacterial substances, which preferably have inorganic adsorbers, such as activated carbon, activated clay earth or silica gel, etc., are also mentioned as antibacterial substances.

From the Japanese patent application JP H08 301362 A, a method for manufacturing a beverage can with an antibacterial coating is also known, in which the antibacterial substances have silver, copper or gold ions in an inorganic adsorber such as zeolite, silica gel or zirconium phosphate. Due to the use of adsorbents for absorbing metal ions, additional manufacturing steps are necessary for both beverage cans known from the prior art in order to provide an antibacterial coating. Zeolite and silica gels also have hygroscopic properties that negatively affect the basic properties of the varnish film, such as water absorption. In addition, activated charcoal, for example, can only be used to a limited extent with regard to the decorative coating of beverage cans, as it does not allow a transparent antibacterial varnish layer, for example.

The US patent application US 2020/267990 A1 examines the antimicrobial properties of inorganic metal salts in a coating. Information on their use in the food sector, such as a coating on beverage cans, is not disclosed. In addition, no surface weights of the coatings are known from the US application. This also applies to the international patent application WO 2019/216598 A, which examines the use of antibacterial substances on surfaces of heat exchangers, refrigerators and dryers.

The article by EZARINA CELA MARDARE ET AL: “Growth inhibition of Escherichia coli by zinc molybdate with different crystalline structures”, PHYS. STATUS SOLIDI A, vol. 213, No. 6, 19 February 2016, XP002786907, investigates the antibacterial effect of ZnMoO₄ in aqueous solutions. There is no information on the use of ZnMoO₄ in the food sector, for example in strip coatings of beverage cans.

The Chinese patent application CN 103 950 981 A discloses a method for the manufacture of ZnMoO₄ and does not give any indication of its use.

According to the teaching of the European patent application EP 2 818 540 A1, resveratol is to be used as an antibacterial substance. There is no reference to the exclusive use of ZnMoO₄.

Although the international patent application WO 2020/084155 A9 discloses the use of ZnMoO₄ in a composite material, no indications are given for the use of this antibacterial substance in the food sector, nor is information on the surface weights of coatings with antibacterial substance disclosed.

From the international patent application WO 2019/216598 A1, an antibacterial coating of objects, for example of core components of air conditioners, refrigerators and clothes dryers, is known which comprises ZnMoO₄.

### SUMMARY OF THE INVENTION

Proceeding from this prior art, the present invention is based on the object of proposing an aluminium strip consisting of an aluminium alloy with at least a one-sided or two-sided, external antibacterial coating that can be manufactured more easily with a very good antibacterial effect of the coating and can already provide very good antibacterial properties with particularly low concentrations of the antibacterial substance.

This object is solved by an aluminum strip according to patent claim 1, a process for manufacturing the aluminum strip according to patent claim 11, a can lid according to patent claim 15, and a can body according to patent claim 17.

According to the present invention, the object shown is achieved by the antibacterial coating containing ZnMoO₄ as the antibacterial substance. It has been shown that zinc molybdate can provide good antibacterial properties even at very low concentrations and can well inhibit the growth of bacteria on corresponding coating surfaces. Zinc molybdate leads to the in-situ formation of free radicals on the surface of the coating in the presence of water or humidity, which have an antibacterial effect. Since zinc molybdate can be used without carrier material, such as zeolite or activated carbon, it can be particularly easily combined with existing coating systems and has an antibacterial effect. According to the present invention the antibacterial coating contains exclusively zinc molybdate as an antibacterial substance. It has been shown that the coatings according to the invention have excellent antibacterial properties even without additional antibacterial agents or agents supporting the antibacterial effect.

According to a first configuration of the aluminium strip, the concentration of zinc molybdate (ZnMoO₄) in the antibacterial coating is at least 0.1% by weight to a maximum of 4% by weight, preferably 0.2% by weight to 2% by weight, preferably 0.25% by weight to 1.0% by weight, further preferably 0.5% by weight to 1.0% by weight in the dry state of the coating. Even at the low concentrations just stated, ZnMoO₄ provides very good antibacterial properties. As a metal salt introduced into the antibacterial coating, the antibacterial substance is thereby not subject to “consumption”, such that the antibacterial effect in connection with the presence of water or air humidity can be permanently provided by the formation of H₃O⁺ ions in situ. Lastly, due to the low concentrations of ZnMoO₄ required to provide the antibacterial property, the further properties of the coating are not affected in the wet or dry state.

It has also been found that an antibacterial-coated aluminium strip according to the invention is readily suitable for the production processes for manufacturing packages of solid, liquid or gaseous products, in particular for manufacturing beverage cans, preferably beverage can lids. Zinc molybdate is also suitable for contact with foodstuffs, such that an inner coating of the package can also be provided. The migration test results for the metals zinc and molybdenum showed particularly low, harmless results. At the proposed concentrations of the coating according to the invention, the antibacterial coating can therefore also come into contact with foodstuffs.

According to of the invention the one-sided or two-sided antibacterial coating of the aluminium strip has a dry weight of 0.5 g/m² to 15 g/m², preferably 2 g/m² to 12 g/m², preferably 3 g/m² to 6 g/m², further preferably 3.5 g/m² to 5 g/m². The dry weight is used to indicate the coating thickness of the aluminium strips of beverage cans. The dry weight of a coating can basically be determined gravimetrically, which is usually also used to calibrate other dry weight measurement methods. Gravimetrically calibrated eddy current measurement methods or near-infrared measurement methods are available as additional methods for measuring the dry weight. Surprisingly, a very good antibacterial effect of the coating on the aluminium strips has already been demonstrated with these low dry weights. The area concentration of the antibacterial substance is preferably only 0.5 mg/m² to 600 mg/m², preferably 1.5 mg/m² to 100 mg/m², preferably 10 mg/m² to 55 mg/m². Even with these low dry weights of the antibacterial substance, a very good reduction in germ colonisation was demonstrated in tests according to ISO 22196. The dry weights of the coating result in coating thicknesses of the aluminium strips, which can be processed without problems in the processing processes of the aluminium strip for the finished package, e.g. beverage can lids.

The antibacterial coating is preferably provided for the external side of the aluminium package that is in direct contact with germs. However, an antibacterial coating of the “inner” side of the aluminium strip that is in contact with the product can also be implemented by means of a one-sided or two-sided antibacterial coating.

Preferably, the aluminium strip has a thickness of 0.1 mm to 0.3 mm, preferably 0.15 mm to 0.25 mm, such that pressure resistant, yet lightweight packages for solid, liquid or gaseous products, in particular for beverage cans, can be manufactured with the aluminium strip.

Preferably, the aluminium strip is an aluminium strip for manufacturing a can, preferably for manufacturing a beverage can, in particular an aluminium can lid strip such that beverage cans can be provided with antibacterial properties without having to fundamentally modify the production processes. The hygiene when drinking from the beverage cans is significantly improved by the use of an aluminium can lid strip according to the invention.

Preferably, the aluminium strip according to a further configuration consists of an aluminium alloy of type A5xxx or A3xxx, preferably of type AA5182 or of type AA3104, AA3105 or AA3004. These aluminium alloy types are often used to provide beverage cans, as they also provide the necessary forming properties in addition to the necessary strength requirements. Aluminium alloys of type AA3xxx are generally more cost-effective to manufacture due to the cheaper starting alloys and the possibility of using recycled materials. Preferably, the recycled content is higher than 60%. However, aluminium alloys of type AA5xxx, in particular AA5182 with a recycled content of more than 50% for example, are also preferably used.

If the antibacterial coating is formed as an antibacterial varnish layer, which contains at least one binder and ZnMoO₄ as an antibacterial substance, common varnish systems with known properties for the antibacterial coating of aluminium strips for the manufacture of packages for solid, liquid or gaseous products, in particular beverage cans, can be provided. The antibacterial substance ZnMoO₄ can thereby be easily mixed into liquid, paste-type or powder-type varnishes. ZnMoO₄ preferably has a particle size of 0.1 μm to 20 μm, preferably 0.5 μm to 5 μm, further preferably 0.5 μm to 2 μm. Reducing the particle size leads to higher efficiency, and, below a particle size of 0.5 μm, the handling of the substance becomes too difficult due to dust generation. With a particle size of more than 20 μm, the antibacterial effect is reduced at identical concentration of the antibacterial substance. Preferably, the antibacterial coating has exclusively ZnMoO₄ as the antibacterial substance. As already mentioned, the sole use of ZnMoO₄ is sufficient, even in low concentrations, to provide excellent antibacterial properties of the coating. All particle sizes mentioned here are mean particle sizes.

In principle, the antibacterial coating can also be applied to the aluminium strip by extrusion coating or lamination due to the temperature stability of ZnMoO₄.

For improved adhesion of the antibacterial coating, the aluminium strip may preferably have at least one chromium-free passivation layer. The aluminium strip preferably only has a surface passivation on the coated side, but a two-sided passivation coating is also conceivable. A zirconium phosphating is preferably used as a passivation layer, which exhibits particularly good adhesive properties in combination with the usual varnish systems for coating the aluminium strips. However, other passivation systems are also conceivable, for example based on titanium and zirconium or based on chrome.

Preferably, the antibacterial coating is resistant to pasteurisation and/or sterilisation. Pasteurisation-resistant or sterilisation-resistant is understood to mean that the antibacterial coating does not exhibit any adverse properties after exposure to temperature under pasteurisation or sterilisation conditions, in particular no discoloration of the varnish or coating or other defects. To test pasteurisation resistance, the sample is heated to 85° C. for 30 minutes. Samples are exposed to hot water at 130° C. for 45 minutes to demonstrate sterilisation resistance. It has been found that zinc molybate harmonises well with the conventional varnish systems and thus varnish systems with particularly good properties with regard to pasteurisation resistance and/or sterilisation resistance can be used. To preserve foodstuffs, they are often subjected to pasteurisation, where the foodstuff is heated to a temperature above 72° C. to 100° C. for a few seconds to reduce the number of germs. These processes are often carried out immediately before the beverage cans are filled, such that the coatings of the beverage can are also exposed to such temperatures. If the coatings are proven to be resistant to pasteurisation or sterilisation according to the above criteria, these coatings are also well suited to the usual pasteurisation or sterilisation conditions.

Pasteurisation-resistant varnish layers are provided according to a further configuration in that the antibacterial coating is a varnish layer on a solvent epoxy resin basis, solvent polyester basis, based on an epoxy resin water dispersion or based on a polyolefin water dispersion. It is also conceivable to use a polyester water dispersion as a varnish layer. All the varnishes mentioned have a high temperature resistance and do not show any yellowing effects, so-called “blushing”, in pasteurisation tests at temperatures of 85° C. for at least 30 minutes. This means that the aluminium cans or packages with corresponding antibacterial coatings can be filled without any problems immediately after pasteurisation of the products. Aqueous or solvent-containing polyester melamine, solvent-containing epoxy melamine, aqueous epoxy acrylate dispersion, aqueous acrylate or polyolefin dispersion, but also polyester acrylate dispersion and alkyd are considered varnish layer systems.

According to the present invention, the object previously shown for a method for manufacturing an aluminium strip is achieved by the aluminium strip being coated on one or two sides with at least one antibacterial coating, with the antibacterial coating containing ZnMoO₄, with the antibacterial coating optionally containing exclusively ZnMoO₄ as an antibacterial substance. As previously mentioned, the antibacterial substance ZnMoO₄ as metal salt is already excellently suited in very low concentrations for the provision of aluminium strips with antibacterial coatings. The coating method can be easily integrated into the manufacturing process of the aluminium strips, such that after cold rolling and an optional heat treatment, the finished-rolled aluminium strips can be coated with the antibacterial coating. However, the aluminium strips are preferably fed to the coating in the full-hard state, H18 or H19.

According to a further configuration of the method, the aluminium strip is subjected to a one-sided or two-sided, chromium-free surface passivation prior to coating the aluminium strip with an antibacterial coating. Zirconium phosphating is preferably performed. The surface passivation is preferably carried out in the no-rinse process, in which the passivation agent is applied to the aluminium strip using a roll coating process and dried. No-rinse processes, i.e. processes without a rinsing step, are more economical and environmentally friendly than processes for surface passivation of aluminium strips with rinsing steps.

Various methods are generally available for applying the antibacterial coating to the aluminium strip. According to an advantageous configuration, the antibacterial coating is applied to the aluminium strip by a one-sided or two-sided coil coating process, preferably using a roll coating process. In coil coating, the coating takes place coil by coil, i.e. the aluminium strip is unwound from one coil, coated and wound or coiled back onto another coil. In the roll coating process, the coating is applied to the aluminium strip by rolling. This allows very precise coating thicknesses to be provided at high coating speeds. Of course, other coating processes are also available in principle, such as spraying or electrostatic spraying of the coating. In addition, the passivation layer can be applied together with the coil coating method for the antibacterial coating, preferably immediately afterwards, i.e. “in line”. This allows the rolling processes of strip manufacture to be carried out independently of the preparation of the aluminium strips for coatings and increases production flexibility.

According to a further configuration of the method according to the invention, the antibacterial coating of the aluminium strip is baked at a maximum metal temperature of 180° C. to 300° C., preferably 230° C. to 260° C., with the baking time being 5 s to 45 s, preferably 8 s to 30 s. With these maximum metal temperatures, the aluminium strip can be transferred from the full-hard state H18 or H19 to the preferred material state H48 or H49, which provides a good compromise between strength and formability for the manufacture of beverage cans, for example. Maximum metal temperatures of 230° C. to 260° C. lead to higher strengths of the aluminium strip while simultaneously hardening the coating reliably. A shorter baking time or a lower baking temperature generally leads to a lower temperature load on the aluminium strip and thus to higher strengths of the aluminium strip. In combination with the aforementioned maximum metal temperature, the aforementioned baking times enable an economical manufacture of the aluminium strip with antibacterial coating while at the same time sufficiently curing the coating.

According to the invention, a can lid of a can, in particular a beverage can, preferably manufactured from an aluminium strip according to the invention is provided by the can lid having a one-sided or two-sided antibacterial coating, with the antibacterial coating containing exclusively ZnMoO₄ as the antibacterial substance. As already mentioned, the antibacterial coating enables the use of very economical process steps for the provision of can lids and can significantly prevent the colonisation of the coated surface with bacterial germs thereon.

The antibacterial coating of the can lid has a dry weight of 0.5 g/m² to 15 g/m², preferably 2 g/m² to 12 g/m² or preferably 3 g/m² to 6 g/m². These dry weights provide both the antibacterial properties on the finished can lid and enable the can lid to be manufactured with consistent antibacterial properties.

According to the invention a can body of a can, in particular a beverage can, manufactured from an aluminium alloy strip is provided in that the can body has a one-sided or two-sided antibacterial coating, with the antibacterial coating containing ZnMoO₄ exclusively as the antibacterial substance.

According to one configuration of the can body, the antibacterial coating has a dry weight of 0.5 g/m² to 15 g/m², preferably 2 g/m² to 12 g/m² or preferably 3 g/m² to 6 g/m². The specific dry weights can provide both the requirements for can body functions such as providing space for product advertising as well as antibacterial properties.

Lastly, a beverage can according to the invention can be provided having a can lid according to the invention and/or a can body according to the invention. Since the beverage can itself often serves as a drinking container, the antibacterial coating according to the invention can significantly improve the hygiene properties of the beverage cans.

### BRIEF DESCRIPTION OF THE DRAWINGS

The invention will be explained in greater detail below by describing exemplary embodiments in connection with the drawing. The drawing shows in:

FIG. 1a and FIG. 1b are embodiments of aluminium strips according to the invention with a one-sided or two-sided antibacterial coating in a schematic sectional view;

FIG. 2 in a perspective representation an exemplary embodiment of a package of a liquid product in the form of a beverage can;

FIG. 3 in a schematic representation an exemplary embodiment according to the method for manufacturing the aluminium strip up to cold rolling the aluminium strip to end thickness and;

FIG. 4 the optional passivation with subsequent coating of the aluminium strip with an antibacterial coating according to an exemplary embodiment in a schematic representation.

### DETAILED DESCRIPTION OF THE INVENTION

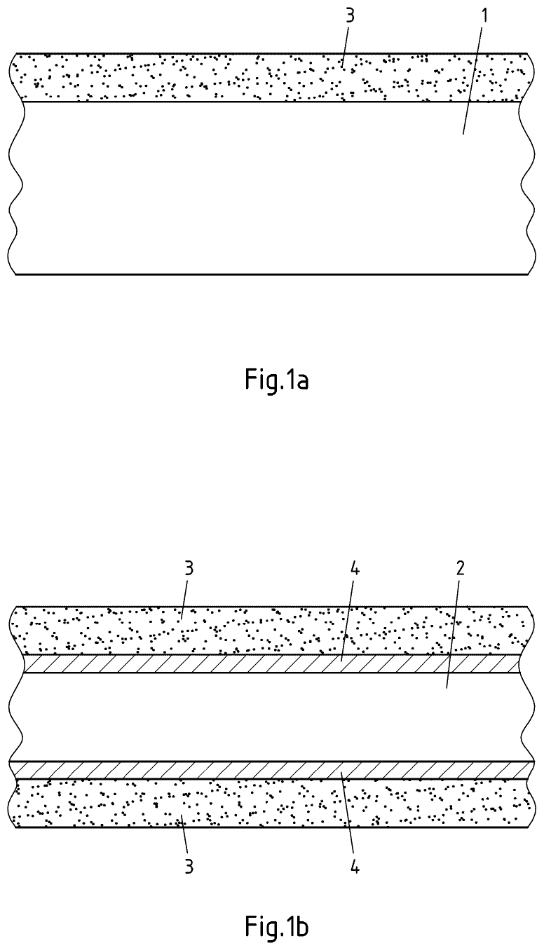

The FIGS. 1a and 1b show exemplary embodiments of aluminium strips 1, 2 in a schematic sectional view in the form of a one-sided coated aluminium strip 1 and a two-sided coated aluminium strip 2. The one-sided or two-sided coating 3 is designed as an antibacterial coating. It contains at least ZnMoO₄ as an antibacterial substance. Preferably, the antibacterial coating contains exclusively ZnMoO₄ as the antibacterial substance. It has been found that even the exclusive use of ZnMoO₄ as an antibacterial substance in the antibacterial coating is sufficient to provide very good antibacterial properties of the surface of the aluminium strip. At the same time, it was found that the metal salt ZnMoO₄ incorporated in the varnish layer of the coating has only very low tendencies to migrate into liquids in contact with the antibacterial coating.

Preferably, the antibacterial coating 3 has concentrations of 0.1% by weight to a maximum of 4% by weight, preferably 0.2% by weight to 2% by weight, preferably 0.25% by weight to 1.0% by weight and further preferably 0.5% by weight to 1.0% by weight of ZnMoO₄. It has been shown that good to very good antibacterial effects can be achieved at these concentrations.

The dry weight of the one-sided or two-sided antibacterial coating of the aluminium strip corresponds to an indication of the thickness of the coating. Exemplary embodiments of the antibacterial coating according to the invention have a dry weight of 0.5 g/m² to 15 g/m², preferably 2 g/m² to 12 g/m², preferably 3 g/m² to 6 g/m², further preferably 3.5 g/m² to 5 g/m². The corresponding dry weights are adapted to the various applications of the aluminium strip in relation to the provision of packages of solid, liquid or gaseous substances, in particular beverage cans. A two-sided antibacterial coating is shown in FIG. 1b.

The aluminium strip 1, 2 of the exemplary embodiments represented in FIGS. 1a and 1b exhibit a thickness of 0.1 mm to 0.3 mm, preferably 0.15 mm to 0.25 mm. Aluminium strips with corresponding thicknesses can be used particularly preferably for the manufacture of beverage cans. Alternatively, however, other packages of solid, liquid or gaseous products can also be manufactured from them.

The aluminium strips 1, 2 preferably consist of an aluminium alloy for packages, in particular beverage cans of type AA5xxx or of type AA3xxx, preferably AA5182 or AA3104, AA3105 or AA3004. The aluminium alloy types mentioned have particularly high strengths and particularly good forming properties. The aluminium alloys of type A3xxx, in particular AA3104, are thereby used for the necessarily less solid regions of a beverage can, i.e. for example for the can body, while the variants of type AA 5xxx, in particular AA5182, are used for the aluminium strip of the can lid.

According to the exemplary embodiment of FIG. 1b, a two-sided antibacterial coating 3 and additionally a passivation layer 4 are provided, which significantly increases the adhesion of the antibacterial coating 3 again. This passivation layer can also be applied only on one side, for example if an antibacterial coating is used on only one side of the aluminium strip. The passivation layer is thereby preferably chromium-free in order to be better suited for contact with foodstuffs. For example, a zirconium phosphating is preferably provided as a passivation layer.

Preferably, the antibacterial coating is formed as an antibacterial varnish layer, which contains at least one binder and ZnMoO₄ as an antibacterial substance. Varnishes are liquid, paste or powder coating materials that contain binders as well as organic solvents and/or water. The binder should thereby form the subsequent coating on the aluminium strip surface. If the binder is mixed with the antibacterial substance ZnMoO₄, the antibacterial substance can be distributed particularly evenly over a large surface of the aluminium strip via the varnish layer. Preferably, the antibacterial substance ZnMoO₄ thereby has a particle size of 0.1 μm to 20 μm, preferably 0.5 μm to 5 μm, further preferably 0.5 μm to 2 μm. Due to the small particle sizes, a very good and homogeneous distribution of the antibacterial substance in the coating can be achieved. As mentioned above, all particle size information is mean particle sizes.

It has been found that the antibacterial substance ZnMoO₄ makes it possible to provide antibacterial varnish layers that are resistant to pasteurisation, as binders that have already been tested can be used here. The pasteurisation resistance was tested for the coatings according to the invention by heating to 85° C. for 30 minutes. After this treatment, the coating should exhibit no or almost no yellowing, also known as “blushing”. The pasteurisation of foodstuffs is usually much shorter in order to keep the ingredients of the foodstuffs unchanged as much as possible.

The same applies to sterilisation resistance, which has been tested by contact with hot steam at 130° C. for 45 minutes. Here, too, the antibacterial substance did not show any negative effects on sterilisation-resistant varnish systems. It is therefore possible to provide antibacterial and sterilisation-resistant aluminium strips.

Preferably, the antibacterial coating 3 consists of a varnish layer on a solvent epoxy resin basis, solvent polyester basis, on the basis of an epoxy resin water dispersion or on the basis of a polyolefin water dispersion.

Epoxy resin-based coatings in particular often have very good temperature resistance and do not show any “blushing” during pasteurisation at 85° C. for 30 minutes at a concentration of up to 4% by weight ZnMoO₄. “Blushing” was also not detected for coatings with 0.5% by weight of ZnMoO₄ under sterilisation conditions in contact with hot steam at 130° C. for 45 minutes.

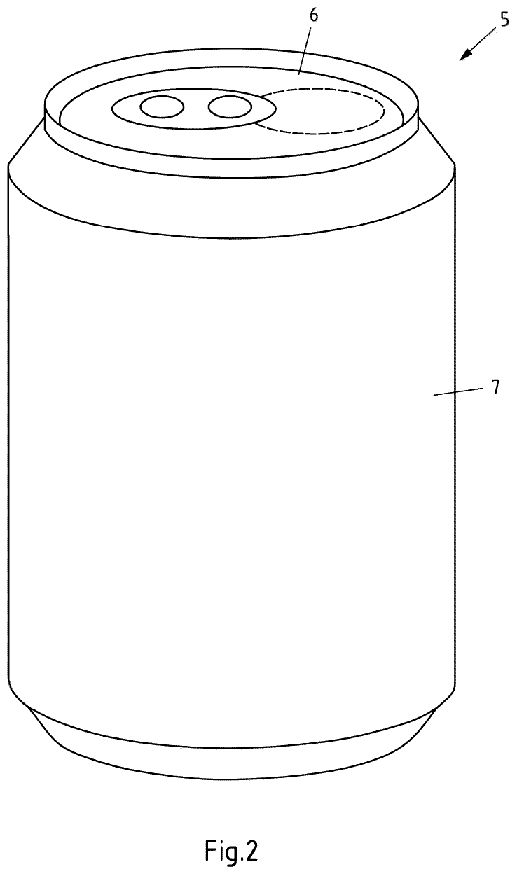

FIG. 2 now shows an exemplary embodiment of a package in the form of a beverage can 5 with a can lid 6 and a can body 7. The can body 7 can also be formed in two parts such that the can is composed of a total of 3 sheet metal parts. According to one exemplary embodiment, the antibacterial coating of the can lid has a dry weight of 0.5 g/m² to 15 g/m², preferably 2 g/m² to 12 g/m² or preferably 3 g/m² to 6 g/m². The can body can also have a dry weight of 0.5 g/m² to 15 g/m², preferably 2 g/m² to 12 g/m² or preferably 3 g/m² to 6 g/m² as an antibacterial coating. Due to the preferred use of the antibacterial coating with exclusively ZnMoO₄, it is possible to further improve hygiene during drinking of beverage cans if, for example, the aluminium can lid strip has a corresponding one-sided or two-sided antibacterial coating. The colonisation of the surface of the beverage can is significantly inhibited even at low concentrations of the antibacterial substance ZnMoO₄ and the number of germs present is significantly reduced within 24 hours.

Corresponding test results show tests of different exemplary embodiments of the invention in comparison with an uncoated zero sample No. 11. The results of the tests are represented in Table 1.

All exemplary embodiments represented in Table 1 have a dry weight of the antibacterial coating of 3.5 g/m² to 4.5 g/m², with the concentration of ZnMoO₄ varying from 0.25% by weight to 2% by weight. As an antibacterial coating, a varnish layer on a solvent epoxy resin basis was used.

The antibacterial effect was tested in accordance with JIS Z2801 and ISO 22196 respectively. Deviating from these standards, the bacterial count of the samples was determined as a double determination with partly different contact times.

4 cm×4 cm coated test surfaces consisting of an aluminium strip according to the invention were previously cleaned with 70% ethanol and then inoculated with a test germ, here Escherichia coli, with an amount of 400 μl/test piece. Some of the samples were rinsed with neutral solution immediately after inoculation and the bacterial count was determined. The other part of the samples was rinsed with neutral solution after specific periods of 2 h, 4 h, 6 h or 24 h in a climatic chamber at 36 +/−1° C. at a relative humidity of more than 90%. The reduction in bacterial count was determined in comparison to the initial bacterial count of untreated test areas.

It has been shown that with an antibacterial coating with 0.25% by weight ZnMoO₄, the number of bacteria could be reduced by more than 99% within 24 hours after a 24-hour test in accordance with JIS Z2801 or ISO 22196. From a content of 0.5% by weight of ZnMoO₄ in the coating, no improvement in the antibacterial effect or reduction of germs could be achieved after 24 hours. The addition of additives, for example polyether-modified polydimethylsiloxane, did not improve the result, as point 4 shows, for example.

An accelerated reduction in the bacterial count was observed when the concentration of ZnMoO₄ was increased after 2 h, 4 h or 6 h. In particular, at 0.5% by weight of ZnMoO₄, the bacterial count was reduced by 92.51% after 6 hours. However, there was a reduction of 97.22% at 1% by weight ZnMoO₄ after 6 h, as shown in sample No. 2 of Table 1.

Sample No. 3 was additionally subjected to a foodstuff regulatory migration test, where a total migration of less than 10 mg/dm² is considered acceptable. Sample number 3 reached 0.16 mg/dm² for zinc and 0.01 mg/dm² for molybdenum after 10 days in contact with 3% acetic acid at a temperature of 60° C. The test conditions were carried out taking into account the requirement in accordance with EU Regulation Number 10/2011 (OM2). Apart from the corrosion of the aluminium strip, only an extremely low migration of zinc and molybdenum of 0.16 mg/dm² or 0.01 mg/dm² for molybdenum could be measured. The antibacterial coating is therefore particularly suitable for contact with foodstuffs.

The non-antibacterial coated sample No. 11 (zero sample) clearly shows that no significant reduction in bacterial count could be achieved after 24 hours. Sample No. 15, containing 0.5% by weight of ZnMoO₄, pasteurised at 85° C. for 30 minutes, showed the highest bacterial reduction count within 24 hours according to ISO 22196. At the same time, no yellowing of the varnish layer (blushing) was found.

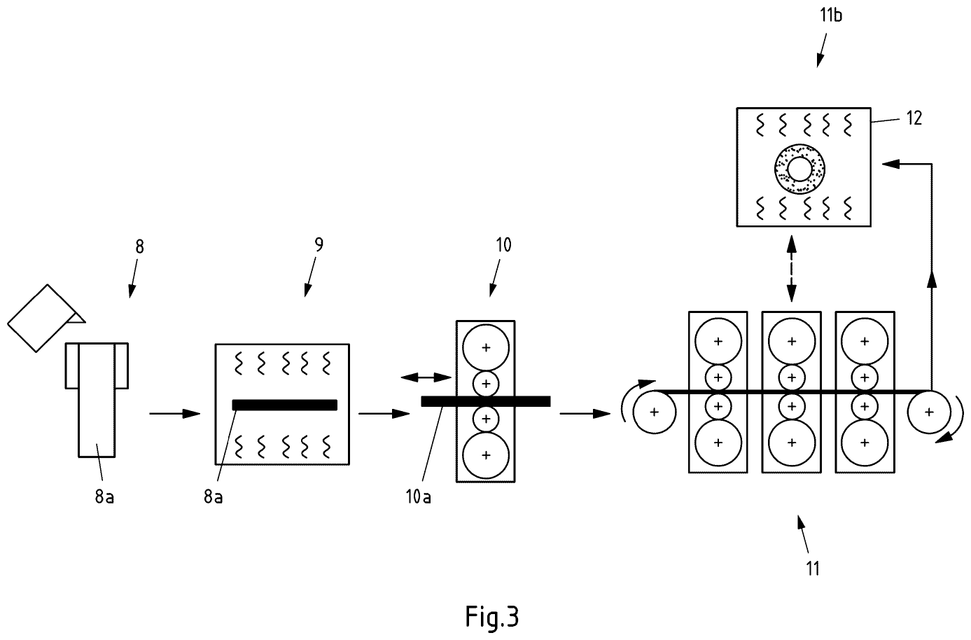

FIG. 3 now shows in a schematic view the individual method steps for manufacturing an exemplary embodiment of the aluminium strip up to the cold rolling of the aluminium strip at end thickness.

First, a rolling ingot 8a is manufactured in step 8, for example in the DC casting process. Similarly, a strip casting not shown here can also be used to manufacture a cast strip. The rolling ingot 8a is then subjected to homogenisation in step 9 and then hot-rolled to form a hot strip 10a in step 10. Hot rolling can be carried out in reversing stands and/or in tandem stands with multiple passes. The hot strip is then cold-rolled to an end thickness in step 11 to form a cold strip 11a. During cold rolling, intermediate annealing can take place in the chamber furnace 12 or in the continuous furnace not shown. A final heat treatment is also not excluded, however, preferably in the full-hard H18 or H19 rolling state, the cold-rolled aluminium strips are fed to the next method step of the coating.

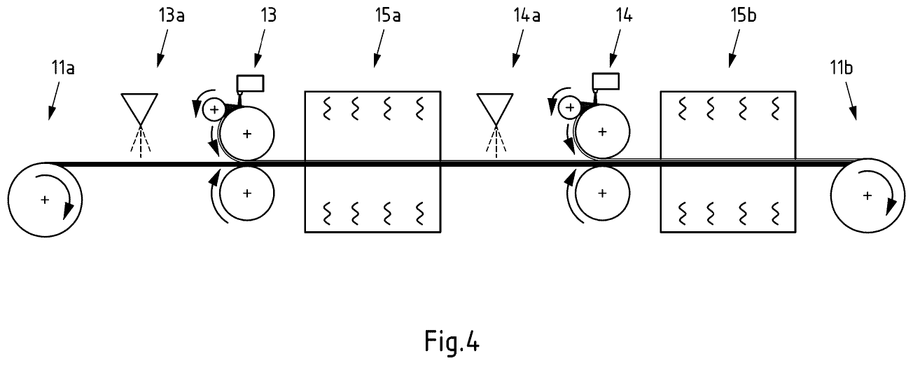

An exemplary embodiment of a coating method is represented in FIG. 4. The cold-rolled aluminium strip 11a is unwound from a coil and fed to a passivation step 13, which is designed here as a roll coating process. Alternatively, the passivation chemical can also be sprayed on, for example electrostatic spraying 13a of the passivation chemical. Alternatively, passivation can also be carried out by passing through a bath with the passivation liquid. However, the roll coating process has proven its worth due to the possible high throughput speeds and the good accuracy of the passivation chemical application. No-rinse processes are preferred for surface passivation, in which the passivation agent, preferably zirconium phosphate, remains on the aluminium strip and does not need to be rinsed off. For this purpose, the aluminium strip 11a is dried in an oven 15a after the passivation chemical has been applied.

The coating of the antibacterial coating is also preferably carried out using a roll coating process 14. Other methods for applying the antibacterial coating, such as spraying or electrostatic spraying 14a, are also conceivable in principle.

Lastly, the baking of the antibacterial coating takes place at a maximum temperature of 180° C. to 300° C., preferably 230° C. to 260° C. in a baking oven 15, in which the maximum metal temperature is maintained for the baking period of 5 seconds to 45 seconds, preferably between 8 seconds and 30 seconds. The aluminium strip 11b provided with an antibacterial coating can then be made available to a manufacturing process of can lids or can bodies.

TABLE 1

| | | Foodstuff | | |
|---|---|---|---|---|
| | | regulatory | Bacteria | |
| | | migration test | (after 24 | |
| | | (EU | h in % | Bacteria |
| | | Regulation No. | reduction) | (% reduction |
| Sam- | | 10/2011 | JIS Z 2801/ | in time |
| ple | Remark | (OM2)) | ISO 22196 | interval) |
| 1 | Coating | | 99.99 | 2 h: 76.00 |
| | with 0.5% | | | 4 h: 82.44 |
| | ZnMoO₄ | | | 6 h: 92.51 |
| 2 | Coating | | 1st | 2 h: 87.33 |
| | with 1% | | Measurement: 99.99 | 4 h: 82.67 |
| | ZnMoO₄ | | 2nd | 6 h: 97.22 |
| | | | measurement: 99.98 | |
| 3 | Coating | Total: <10 | 99.99 | |
| | with 2% | mg/dm² | | |
| | ZnMoO₄ | Zinc: 0.16 | | |
| | | mg/dm² | | |
| | | Molybdenum: | | |
| | | 0.01 mg/dm² | | |
| 4 | Coating | | 99.99 | |
| | with 1% | | | |
| | ZnMoO₄ | | | |
| | and 5% | | | |
| | additives | | | |
| 11 | Zero | | none | 2 h: 18.67 |
| | sample | | | 4 h: 41.56 |
| | | | | 6 h: 62.89 |
| 12 | Coating | | 99.84 | |
| | with | | | |
| | 0.25% | | | |
| | ZnMoO₄ | | | |
| 15 | Coating | | ≥99.99 | |
| | with 0.5% | | | |
| | ZnMoO₄ | | | |
| | Pasteurised | | | |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An aluminium strip for manufacturing a package of a solid, liquid or gaseous product consisting of an aluminium alloy, wherein the aluminium strip has at least a one-sided or two-sided antibacterial coating,
wherein
the antibacterial coating contains exclusively ZnMoO₄ as an antibacterial substance and
the antibacterial coating of the aluminium strip has a dry weight of 0.5 g/m² to 15 g/m².

2. The aluminium strip according to claim 1,
wherein
the concentration of ZnMoO₄ in the antibacterial coating is at least 0.1% by weight to a maximum of 4% by weight, preferably 0.2% by weight to 2% by weight, preferably 0.25% by weight to 1% by weight, further preferably 0.5% by weight to 1% by weight.

3. The aluminium strip according to claim 1,
wherein
the one-sided or two-sided antibacterial coating of the aluminium strip has a dry weight of 2 g/m² to 12 g/m², preferably 3 g/m² to 6 g/m², further preferably 3.5 g/m² to 5 g/m².

4. The aluminium strip according to any one of claim 1,
wherein
the aluminium strip has a thickness of 0.1 mm to 0.3 mm, preferably 0.15 mm to 0.25 mm.

5. The aluminium strip according to claim 1,
wherein
the aluminium strip is an aluminium strip for manufacturing a can, preferably an aluminium strip for manufacturing a beverage can, in particular an aluminium can lid strip.

6. The aluminium strip according to claim 1,
wherein
the aluminium strip consists of an aluminium alloy of type AA5xxx or AA3xxx, preferably AA5182 or AA3104.

7. The aluminium strip according to any one of claim 1,
wherein
the antibacterial coating is formed as an antibacterial varnish layer, which contains at least one binder and ZnMoO₄ as an antibacterial substance.

8. The aluminium strip according to any one of claim 1,
wherein
the aluminium strip has at least a one-sided or two-sided chromium-free passivation layer.

9. The aluminium strip according to any one of claim 1,
wherein
the antibacterial coating is resistant to pasteurisation and/or sterilisation.

10. The aluminium strip according to any one of claim 1,
wherein
the antibacterial coating is a varnish layer on a solvent epoxy resin basis, on a solvent polyester basis, based on an epoxy resin water dispersion, a polyester water dispersion or based on a polyolefin water dispersion.

11. A method for manufacturing an aluminium strip according to claim 1, in which a rolling ingot or a casting strip is cast from an aluminium alloy, the rolling ingot or optionally the casting strip is homogenised, the rolling ingot or the casting strip is hot-rolled to form a hot strip, the hot strip is cold-rolled to an optional end thickness of 0.1 mm to 0.3 mm with at least one intermediate annealing or without intermediate annealing and optionally subjected to a final heat treatment,
wherein
the aluminium strip is coated on one or both sides with at least one antibacterial coating, wherein the antibacterial coating contains exclusively ZnMoO₄ as an antibacterial substance and the antibacterial coating of the aluminium strip has a dry weight of from 0.5 g/m² to 15 g/m².

12. The method according to claim 11,
wherein
the aluminium strip is subjected to a one-sided or two-sided chromium-free surface passivation after cold rolling at the end thickness.

13. The method according to claim 12,
wherein
the antibacterial coating is applied to the aluminium strip by a one-sided or two-sided coil coating process, preferably using a roll coating process.

14. The method according to any one of claim 11,
wherein
the antibacterial coating is baked at a maximum metal temperature of 180° C. to 300° C., preferably at 230° C. to 260° C., wherein
the baking time is between 5 s and 45 s, preferably between 8 s and 30 s.

15. A can lid of a can, in particular a beverage can manufactured from an aluminium strip according to claim 1,
wherein
the can lid has a one-sided or two-sided antibacterial coating, wherein the antibacterial coating contains exclusively ZnMoO₄ as an antibacterial substance and the antibacterial coating of the can lid has a dry weight of 0.5 g/m² to 15 g/m².

16. Can lid of a can according to claim 15,
wherein
the antibacterial coating of the can lid has a dry weight of 2 g/m² to 12 g/m² or preferably 3 g/m² to 6 g/m².

17. Can body of a can, in particular a beverage can manufactured from an aluminium strip,
wherein
the can body has a one-sided or two-sided antibacterial coating, wherein the antibacterial coating contains exclusively ZnMoO₄ as an antibacterial substance and the antibacterial coating of the can body has a dry weight of 0.5 g/m² to 15 g/m².

18. Can body of a can according to claim 17,
wherein
the antibacterial coating of the can body has a dry weight of 2 g/m² to 12 g/m² or preferably 3 g/m² to 6 g/m².
